(19) United States
(12) Patent Application Publication
(10) Pub. No.: US 2013/0201711 A1
(43) Pub. Date: Aug. 8, 2013

(54) Structure of vehicle taillight indicator housing mountable flush to a flat surface made by simplified method of producing a vehicle taillight indicator that includes a polystyrene foam core by sheet metal bending and fastening of the polystyrene foam core

(71) Applicant: Thomas Howard Radgens, Dearborn, MI (US)

(72) Inventor: Thomas Howard Radgens, Dearborn, MI (US)

(21) Appl. No.: 13/385,112

(22) Filed: Feb. 3, 2012

(51) Int. Cl. B60Q 1/30; B23P 17/00; F21V 7/00

(52) U.S. Cl. 362/516; 29/527.1

(57) ABSTRACT

A vehicle taillight indicator is mounted flush to a flat surface such that its convex reflector curves left to right and right to left inward from the flat surface and reflects a light source as a vertical line. The taillight indicator is situated so that it is viewable in the rear view mirror or side view mirror of a vehicle. Each operating taillight of a vehicle is reflected as a vertical red line in the convex reflector of the taillight indicator. A vehicle with two operating taillights will reflect two parallel vertical red lines in the convex reflector of the taillight indicator.

### BACKGROUND OF THE INVENTION

My patented invention U.S. Pat. No. 8,069,548 (Dec. 6, 2011) METHOD OF PRODUCING A VEHICLE TAILLIGHT INDICATOR THAT INCLUDES A POLYSTYRENE FOAM CORE BY SHEET METAL BENDING AND FASTENING OF THE POLYSTYRENE FOAM CORE specifies a housing that is V shaped with two V shaped end covers and two mounting brackets. If the V shaped housing is expanded close to 180° or if two 90° V shaped housings are fastened together they are not mountable flush to a flat surface because the protruding end covers and protruding mounting brackets interfere with this installation. This is a costly time consuming problem.

### SUMMARY OF THE INVENTION

I have improved the structure of the vehicle taillight indicator making it mountable flush to a flat surface by simplifying the method to produce a vehicle taillight indicator that includes a polystyrene foam core by sheet metal bending and fastening of the polystyrene foam core by eliminating the two protruding V shaped end covers and two protruding mounting brackets to produce a one piece housing made of sheet metal which has a smooth, flat outer back surface that can be fastened flush to any flat surface by four or more screws through mounting holes through the back of the housing.

### BRIEF DESCRIPTION OF THE DRAWING

FIG. 1 is a plan view of the blank 8 with two identical opposite long outward curved edges of equal length and two opposite short parallel edges of equal length.

FIG. 2 is a perspective view of the housing 10 showing the inner flat rectangular back surface 16 with four mounting holes 14 and long curved convex top 20 with assembly hole 12 and left end view with outer back surface 18 and bottom 22.

FIG. 3 is a front elevation view of an assembled vehicle taillight indicator showing the long curved convex top 20 with convex reflector 26 and sheet metal screw 28.

FIG. 4 is an exploded view of the vehicle taillight indicator showing the inner back rectangular surface 16 of the housing 10 with four mounting holes 14, long curved convex top 20 with assembly hole 12, identical long curved convex bottom 22 with assembly hole 12, polystyrene foam core 24, convex reflector 26 and two sheet metal screws 28.

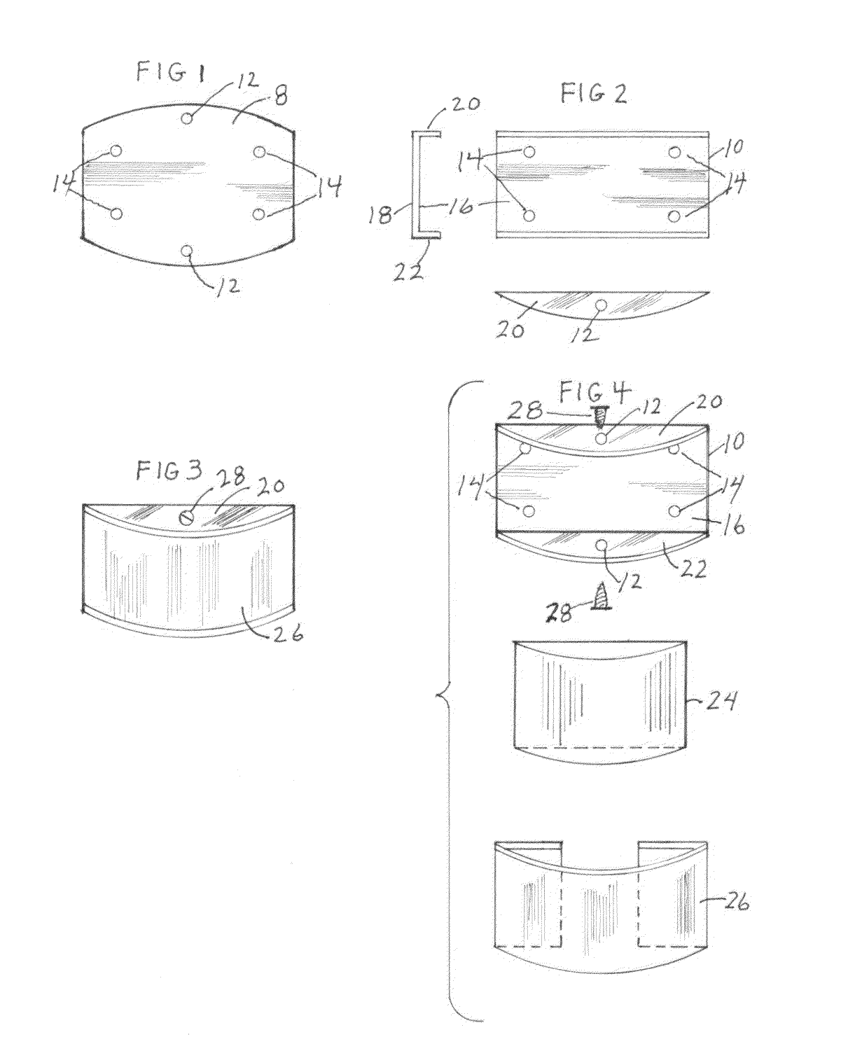

### DETAILED DESCRIPTION OF THE INVENTION

A vehicle taillight indicator with improved housing 10 mountable flush to a flat surface is produced by cutting sheet metal to form a blank 8 with two long identical opposite outward curved edges of equal length and two short identical opposite parallel edges of equal length. An assembly hole 12, centered close to each opposing outward curved edge, is drilled through the blank 8. Four or more mounting holes 14 are drilled through the center portion of the blank 8. The two long identical opposite outward curved sections of the blank 8 are folded inward perpendicular to the center portion of the blank 8 to form a rectangular shaped housing 10 having four mounting holes 14, two short identical opposite parallel edges of equal length and two long identical curved convex sides of equal length with assembly holes 12. The polystyrene foam core 24 is molded to the same shape as the flat inner rectangular back surface 16 of the housing 10 and formed to curve inward from the inner rectangular back surface 16 of the housing 10 to match the two long identical curved convex sides of the housing 10 and the two parallel edges of the housing 10. A convex reflector 26 is made by cutting and bending a semi-reflective piece of sheet metal to fit over and attach to the curved convex side of the rectangular shaped polystyrene foam core 24. The polystyrene foam core 24 with the attached convex reflector 26 is placed within the housing 10 with the convex reflector 26 showing and fastened to the housing 10 by means of sheet metal screws 28 through assembly holes 12 through each long identical curved convex side of the housing 10, thereby completing the vehicle taillight indicator.

A user of the vehicle taillight indicator chooses a location with a flat surface, to install the vehicle taillight indicator, that is viewable in the rear view mirror or side view mirror of the vehicle. The user removes the two sheet metal screws 28 through assembly holes 12 through the two long identical curved convex sides of the housing 10 and removes the polystyrene foam core 24 with the attached reflector 26. The vehicle taillight indicator housing 10 is placed against the flat surface of the chosen location and arbitrarily positioned and leveled so that the two identical curved convex sides of the housing 10 curve inward from the flat surface left to right and right to left becoming the long curved convex top 20 and the long curved convex bottom 22 of the vehicle taillight indicator. The housing 10 of the vehicle taillight indicator is fastened to the flat surface with at least four screws through the mounting holes 14 through the rectangular back of the housing 10. The polystyrene foam core 24 with the attached convex reflector 26 is replaced within the housing 10 and fastened to the housing 10 with a sheet metal screw 28 through the assembly hole 12 through the top 20 and with a sheet metal screw 28 through the assembly hole 12 through the bottom 22 completing the installation. The user checks the taillights from within the vehicle by observing, in the rear view mirror or side view mirror, a vertical red line in the convex reflector 26 of the vehicle taillight indicator for each operating taillight of the vehicle.

Based upon the foregoing discussion I am of the opinion that my invention has fulfilled a long-felt need in the field of automobile safety and that I have made a valuable contribution to the related art; however while the invention is described with reference to the structural details of a single embodiment, the principles involved are susceptible of numerous other practical adaptations.

Therefore I claim:

1. A vehicle taillight indicator that reflects multiple light sources as parallel lines.

2. A method of producing a vehicle taillight indicator having a housing that is mountable flush to a flat surface and retains a convex reflector which curves inward from the flat surface left to right and right to left that reflects operating taillights of a vehicle as parallel vertical red lines comprising the steps of:
cutting a piece of sheet metal to form a blank with two long identical opposite outward curved edges of equal length and two identical opposite short parallel edges of equal length;
drilling an assembly hole through the blank centered close to each long identical opposite outward curved edge;
drilling four or more mounting holes through the center portion of the blank;
bending the two long identical opposite outward curved sections of the blank perpendicular to the inner portion of the blank to create a housing with a flat rectangular back with four or more mounting holes, two short opposite parallel edges of equal length and two long identical curved convex sides of equal length, each having ah assembly hole;
molding polystyrene foam to the same shape as the inner flat rectangular back of the housing;
forming the polystyrene foam opposite its flat side to a convex curvature to match the two long identical curved convex sides of the housing to form a polystyrene foam core;
cutting a piece of semi-reflective sheet metal to a rectangular shape similar to the polystyrene foam core;
bending the rectangular shaped semi-reflective sheet metal to fit over the curved convex side of the polystyrene foam core to form a convex reflector;
attaching the convex reflector to the polystyrene foam core;
placing the polystyrene foam core within the housing with the attached convex reflector showing; and
fastening the polystyrene foam core within the housing with sheet metal screws through the assembly holes through the two long identical curved convex sides of the housing, thereby forming the vehicle taillight indicator.

3. The method as claimed in claim 2, further comprising:
choosing a location with a flat surface to install the vehicle taillight indicator so that it is viewable in the rear view mirror or side view mirror of a vehicle;
removing the sheet metal screws from the assembly holes through the two long identical curved convex sides of the housing;
removing the polystyrene foam core with the attached convex reflector from the housing;
orienting the housing so that the two long identical curved convex sides are in the top and bottom positions and curve inward from the flat surface left to right and right to left;
leveling the housing to ensure that a light source is reflected as a vertical line in the convex reflector;
fastening the housing to the flat surface of the chosen location with screws through the mounting holes through the back of the housing;
replacing the polystyrene foam core with the attached convex reflector showing;
fastening the polystyrene foam core within the housing with sheet metal screws through the assembly holes through the top side and bottom side of the housing into the polystyrene foam core; and
checking the taillights of the vehicle by observing a vertical red line in the convex reflector of the vehicle taillight indicator for each operating taillight of the vehicle.
